(19) United States
(12) Patent Application Publication
(10) Pub. No.: US 2003/0014326 A1
(43) Pub. Date: Jan. 16, 2003

(54) Method for buy-side bid management

(75) Inventors: Eytan Ben-Meir, Santa Clara, CA (US); Avraham Goraly, Santa Clara, CA (US)

Correspondence Address: David A. Jakopin, PILLSBURY WINTHROP LLP, 1600 Tysons Boulevard, McLean, VA, 22102, US

(73) Assignee: Webango, Inc.

(21) Appl. No.: 10/165,491

(22) Filed: Jun. 6, 2002

Related U.S. Application Data
(63) Continuation of application No. 09/603,116, filed on Jun. 22, 2000.
(60) Provisional application No. 60/141,530, filed on Jun. 23, 1999.

(51) Int. Cl. G06F 17/60

(52) U.S. Cl. 705/26; 705/27

(57) ABSTRACT

A web-based enterprise application system facilitates strategic e-sourcing for both buyers and vendors. The system provides automation capabilities in both strategic partner selection (providing buyers and vendors with the tools necessary to choose the most suitable long-term business partner or partners) and strategic partner management (providing buyers and vendors with tools and content to build and maintain long-term value-added business relationships). For the former, the system provides an RFP management platform that helps buyers to manage the RFI/RFP process from requirement definition to negotiation and a counterpart proposal management platform that helps vendors to respond to requests for information and proposals by providing them with a flexible, accurate and intuitive online framework. For the latter, the system provides a contract management platform which helps buyers and vendors to build and maintain contracts to further long-term value-added business relationships.

### CROSS-REFERENCE TO RELATED APPLICATION

This application is related to and claims priority under 35 U.S.C. §119 from U.S. Provisional Application Serial No. 60/141,530, incorporated herein by reference.

### BACKGROUND OF THE INVENTION

1. Field of the Invention

The present invention is directed to data processing systems for facilitating the formulation and negotiation of contracts. More particularly, the invention is directed to such systems which are used in strategic sourcing programs and the like.

2. Background of the Related Art

Purchasing is a core enterprise process with high and rapidly increasing importance. Purchasing expenses take away up to 60% of corporate revenues. Streamlining the process is one of the top priorities of CEOs in the U.S. Solicitation of vendor bids is one of the main processes used in purchasing. As opposed to catalog purchasing, this process is used in the procurement of customized assets and services. It involves definition of requirements, communication with bidders and receipt, analysis and comparison of competitive bids.

Presently, the bid solicitation process is laborious, costly and extremely time-consuming. It requires the efforts of highly qualified personnel for weeks, sometimes months. As a result, corporate buyers avoid soliciting bids, or solicit bids from a very limited number of vendors. By avoiding large-scale bids, companies forego price-savings of as much as 20% and often make sub-optimal selections, which result in losses of millions of dollars.

Strategic e-sourcing is an emerging technology in the electronic procurement art. The manual process of formulating, bidding for, and negotiating a strategic sourcing contract is time-consuming and often inaccurate. It includes lengthy market research, generation of complex Requests for Information (RFIs), Requests for Quotations (RFQs), Requests for Proposal (RFPs) and proposal documents, sophisticated proposal analysis, heavy negotiations, and on-going contract management. The strategic sourcing process is used in the one-time procurement of high-value/critical assets or services, and in the selection and management of long-term vendors.

In the future, web-based bid enabling technologies targeted at buyers could make bid solicitation fast and inexpensive and turn it into the preferred method of procurement for the following main reasons. First, a fast and inexpensive bidding process transfers control over the transaction to the buyer. Buyers will not need to shop through multiple catalogues. They will be able to define their requirements and let vendors come with offers. Buyers will use bidding for the purchase of various simple assets as well as for more complex purchases. They will be able to add custom preferences to any purchase and select vendors according to multiple criteria, rather than just price.

Second, purchasing through bids has proven to result in lower purchase prices by an average of 20%. Such savings are likely to have direct impact on the organization's bottom-line. What is needed in the art is a system which streamlines the bidding process in its full range—from the simplest RFQ, used for price checking, to the formal Request For Proposal RFP, used for the solicitation of bids for complex purchases, where multiple quantitative and qualitative criteria are involved.

### SUMMARY OF THE INVENTION

In view of the above problems of the prior art, it is an object of the present invention to provide a system which supports buyers and vendors in the process of selecting the best long-term business partner and managing the on-going relationship therewith.

It is a further object of the present invention to provide a system which supports both the selection of a strategic partner and the management of the relationship.

It is yet another object of the present invention to provide a system which supports the long-term relationship between buyers and vendors by improving contract visibility, performance management, and communication.

It is still another object of the present invention to provide such a system which considers development and management of the contracting relationship as important as making the right selection.

It is a further object of the present invention to provide such a system which utilizes the power of the Internet to make this sophisticated and time-consuming process fast, easy, and accurate.

It is a yet further object of the present invention to provide a system which supports very complex and relatively simple projects equally well.

It is another object of the present invention to provide a system which allows buyers to receive better value for their money by buying more under strategic contracts.

It is an additional object of the present invention to provide a system which offers sophisticated functionality for creating RFP/RFI documents, analyzing proposals, negotiating complex contracts, managing contracts, and managing vendor performance.

It is still another object of the present invention to provide a system which brings additional revenues to vendors by increasing their exposure to potential clients and shortening their sale cycles.

The above objects are achieved according to a first aspect of the present invention by providing a web-based enterprise application system facilitating strategic e-sourcing for both buyers and vendors. The system provides automation capabilities in both strategic partner selection (providing buyers and vendors with the tools necessary to choose the most suitable long-term business partner or partners) and strategic partner management (providing buyers and vendors with tools and content to build and maintain long-term value-added business relationships). For the former, the system provides an RFP management platform that helps buyers to manage the RFI/RFP process from requirement definition to negotiation and a counterpart proposal management platform that helps vendors to respond to requests for information and proposals by providing them with a flexible, accurate and intuitive online framework. For the latter, the system provides a contract management platform which helps buyers and vendors to build and maintain contracts to further long-term value-added business relationships.

### BRIEF DESCRIPTION OF THE DRAWINGS

These and other objects, features and advantages of the present invention are better understood by reading the following detailed description of the preferred embodiment, taken in conjunction with the accompanying drawings, in which:

FIG. 1 shows the system architecture of a preferred embodiment of the present invention;

FIG. 2 shows a bid solicitation document generation process according to the preferred embodiment;

FIG. 3 shows a bidding process according to the preferred embodiment;

FIGS. 4A and 4B show a bid evaluation process according to the preferred embodiment.

### DETAILED DESCRIPTION OF PRESENTLY PREFERRED EXEMPLARY EMBODIMENTS

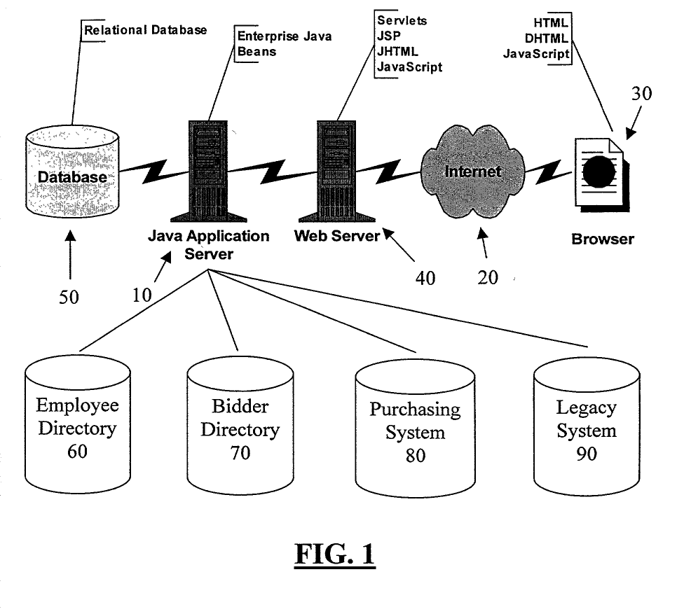

A system according to a preferred embodiment of the present invention is shown in FIG. 1. Here, the core enterprise application system is maintained on Java application server 10. The application server 10 runs the enterprise application software, preferably written in Sun Microsystems' Enterprise Java Beans language, to generate web pages served over the Internet 20 to a buyer or vendor's browser running a client application 30 by a web server 40. To generate web pages providing information on existing contracts, descriptions of buyers and vendors and the like, the application server 10 may access a relational database 50 using a relational database language such as SQL as is known in the art. Preferably, the web server 40 can use HTML or other web-based software mechanisms such as servlets, JSP, JHTML and JavaScript to deliver the web page to the client application 30. Also, it is preferable that the client application 30 understands the HTML, DHTML and JavaScript languages and can properly use the browser to display pages incorporating one or more of them. Communication between the client application 30 and server 10 may be in a suitable language such as XTML as described in greater detail below.

The application server application 10 produces the permanent state of the system. This is where the application entities live and communicate. When a user updates the state of an application entity from the entity's view, an update of the entity is initiated and programmatic relationships are exercised in order to produce a consistent system state. When, necessary changes are updated on the underlying database to make them persistent and when necessary, updates of views on the client application are initiated. The server application also takes care of issues like user management, access control, security, concurrent user support, user session management and the like.

The web server 40 is for allowing multiple browser clients to access the server application. For that reason it contains a servlet, or equivalent web server extension such as a CGI script, whose purpose is to move data back and forth between web clients and their respective client sessions on the server application.

Data moving between the web server 40 and the client application 30 may need to be compressed for communication optimization reasons, or encoded for security reasons. The communication element should be independent of the compression/decompression activity, the encoding/decoding activity and their nature.

Since HTTP requests and responses can only contain string data, there is a need for serialization of message objects to a string and deserialization of message objects from a string. This serialization and deserialization should be achieved in a way that does not affect the rest of the code handing the communication session in any way. This independence will allow dynamic extension of the system by addition of new message objects without affecting any operational code.

Within the web server 40, a communication servlet is the entry point from the client application 30 through the Internet 20 to the web server 40 and the application server 10. A message packet interface is the interface of the messages exchanged by the client application 30 and the application server 10. This interface is sufficiently rich to allow routing of message packets and to allow bundling and unbundling of individual messages. An object serialization utility performs serialization of transmitted data so that it can be conveyed using the HTTP protocol as noted above as well as deserialization of received data. The serialized data passes through an object serializor interface. An object encode/decode utility performs encryption of transmitted data and decryption of received data as noted above. The encoded data passes through a data encoder/decoder interface.

A serialized message is an XML tag-delimited string. Each message is enclosed by a message tag pair.

message tag—<message></message>

ID tag—<id></id>

source ID tag—<sourceid></sourceid>

target ID tag—<targetid></targetid>

op-code tag—<opcode></opcode>

priority tag—<priority></priority>

datatag—<data></data>

A packet is serialized as follows:

packet tag—<pack></pack>

packet header tag—<packhead></packhead>

ID tag—<id></id>

session ID tag—<sessionid></sessionid>

user name tag—<user></user>

For example,

<pack>

<packhead>

<id>1234</id>
<sessionid>us1234</sessionid>
<user>jhond</user>

</packhead>
<message>

<id>1</id>
<sourceid>c77</sourceid.
<targetid><appent70de3>/targetid>
<opcode>UPDATE</opcode>
<priority>1</priority>
<data>

<header><h3>New header text</h3></header>
<body><p class=‘text’>New body text</p></body>

</data>

</message>
. . .

</pack>

A message is the atomic unit of program level communication between the client application 30 and the application server 10. It consists of program level information including error messages or negative responses to requests. The communication layer is unaware of the contents of the messages it transfers back and forth. A request message includes a message ID which is unique within the scope of the client application 30; a source ID which is a unique ID of the GUI element which originated the message and expects the response; and a target ID which is the ID of the application entity which is the intended recipient of the message and the expected responder. The request message also includes an operation code which is typically a verb describing the general type of action required, e.g., UPDATE, DELETE, etc.; a priority field used to expedite time dependent messages when doing so may improve application performance or user experience; and data which provides the detailed information of the message.

A response message includes a unique ID of the message, which should correspond to the ID of the original message; a source ID which is the unique ID of the application entity which generated the response; and a target ID which is the unique ID of the GUI component that generated the original request message and is expecting the response. The response message also includes an operation code which is typically an adjective describing the general type of result of attempting to fulfill the original request message, e.g., OK, ERROR, etc.; a priority field used to expedite time-dependent messages when doing so may improve application performance or user experience; and data which is the detailed information of the message.

Messages between the client application server 30 and the application server 10 are bundled together in packets for communication optimization reasons. The message packet is the atomic unit of transmission of data between the client application and the server. All communication events such as time-outs, communication errors and normal responses are handled at the message packet level. For this reason, a message packet should contain a unique identifier. The message packet has an ID which is used to relate the packet with the corresponding response packet, and a unique session ID used to control access and provide data integrity. The message packet also includes a user ID used for security and access control purposes.

The client application 30 performs communication with the server by posting request message packets on the request interface of the communication applet. Every request message packet consists of several messages bundled together. A request message packet will contain an ID supplied by the JavaScript bundling software that is used to associate it with its response. A request message packet contains information that will be used by the receiving side web server 40 to identify the client session it originated in for security and access control.

Normal responses will be posted by the communication applet on its normal response stack. A normal response is a message packet containing responses for all its member messages as well as the ID of the original request message packet.

There are two possible error responses. Communication errors are always at the packet level, which is the atomic unit of transmission. Reporting on communication errors is done by posting an error response message packet on the error message packet stack interface of the communication applet. The error response message packet contains a message that describes the errors. Program errors are always at the message level, which is the atomic unit of program communication. Reporting on program errors is done via the normal response mechanism. The response to any message may be an error response which contains an error opcode as well as data describing the error.

With the use of advanced server-side technologies such as the above, the preferred embodiment can provide rich and interactive functionality to the browser 30 without the use of any plug-ins, thereby enabling the use of a thin HTML client as the browser 30. In terms of speed and functionality, this can result in a web-based system with the characteristics of a desktop application. The overall flexibility of the system architecture should allow for the input of almost any type of content and generation of bid solicitation documents for any type of asset or service.

One objective of the thin browser client 30 is to create a desktop-like user experience where changes to application state that may contain server update do not result in browser page reload. For that purpose the client application 30 shows dynamically generated HTML views of server application entities. When the state of a view changes and a server update occurs, a request to update is sent to the server. An update of other views may occur as a result of the initial server update.

Each application entity can have one or more client views. An update to an application entity will be reflected among all displayed client views. Furthermore, if an application entity is modified by User A, and User B displays a view of that entity, the User B view should be updated to reflect the change User A made. This implies that every view should listen, through its peer, to changes occurring in its application entity. Also, each peer should repeatedly check the validity of its state, and update accordingly.

The client application 30 supports cascading updates, in which an update of a specific application entity causes updates of additional application entities. This, of course, should cause an update of views of these entities if currently displayed. Further, it is preferable that the client 30 implements a background updating technique. To do this, the client 30 will not update its display independently, but will wait for the update to be granted by the application server 10 before doing so.

Since communication failures are a major cause of data loss, such problems should be detected as soon as possible. This will be done using a regular, timeout-based communication check with a relatively high frequency. If this check fails the user is notified so that no further data is updated on the client 30 until communication is again established. The client's communication layer is responsible for performing this check and for notifying subscribers of a “no communication” event as well as of a “communication established” event.

After every successful server operation, the server will send an acknowledgement to the client application. Only when the client view receives the server acknowledgement can it assume that an update operation was terminated. This will ensure tighter control over data-loss conditions and will enable the system to inform users when it is safe to log out of the client application 30. Also, it is possible for the application server 10 to deny an update process initiated by a client view—for instance, if the view's application entity is locked by another user. In this case, the acknowledgement returned by the server to the view's peer should include an error code and/or an error message.

The server-client protocol has two basic sections, a client message and a server acknowledgement. The client message is sent from the client 30 to the server to update the state of an application entity on the server, thereby reflecting a change to that entity made by the user on the client application 30. The client message includes a source ID and a target ID. The source ID is the ID of a client application's object which will get the acknowledgement from the server. This will usually be the ID of a peer object through which the message was sent. The target ID is the ID of the application entity which was updated. It is used by the application server 10 to access the reflected entity on the database and update it in the same manner. The client message also includes an operation code which indicates the type of operation executed on the application entity and data to be updated on the application server 10. A data ID included in the client message is unique within the scope of the sending peer and allows the sending client view to send an update request before getting an acknowledgement for a previous update request. Finally, a priority field in the message indicates the priority of the message.

The server acknowledgement is sent from the application server 10 to the client to grant operation completion on the client side.

Preferably, the system is interfaced to several other systems. First, the system preferably interfaces with a directory or other system 60 which allows access to information about the organization's employees, including name, telephone number, e-mail address, department, title, area of expertise and the like. Also, the system preferably interfaces with a bidder directory system 70 which provides information about the organization's vendors, including vendor name, description, contact name, contact title, contact e-mail, contact phone, URL, address, industry, size, business classification and the like. Further, the system preferably interfaces with a purchasing system 80 which enables it to access all contract and award information to generate purchase orders.

As used herein, a bid solicitation document is a collection of requirements that need to be met in order to solve a corporate need. Requirements are specific characteristics that possible solutions have to possess in order to solve a corporate need.

Preferably, messages from a client to the application server 10 are written in an Extensible Markup Language (XML) and are of the form

<update>

<header>header string</header>
<body>body string</body>

</update>

To add a new element to the child elements collection of an object, e.g., to add subsidiary requirements to a contract requirement as will be described in greater detail below, the body string includes, e.g.,

add at index

<add><child index=value type=value></child></add>

add to beginning

<add><child index=0 type=value></child></add>

add to end

<add><child index=last type=value></child></add>

To delete a child element at an index,

<deleteIndex>value</deleteIndex>

<deleteEntity>value</deleteEntity>

To retrieve entities from the server,

<retrieve header body children></retrieve>

Messages from the server to a client element supply the requested entity and take the form

<update>

<header>header string></header.
<body>body string</body>
<children>

<child ID=value type=value></child>. . .

</children>

</update>

The basic component of a document in the system is the document element. A document element has a header and body, and it can contain other document elements. A special type of document element is the requirement. Requirements are preferably of the form

<update>

<header> headerXML </header>
<body> bodyXML </body>
<children alloc=val locked=val > childrenXML </children>
<range min=val max=val type=type> rangeXML </range>

</update>

where each of the header, body, children and range lines are optional. HeaderXML has the

following structure:

<text>headerText </text>

<style>headerStyle </style>

bodyXML has the following structure:

<text>headerText </text>

<style>headeStyle </style>

childrenXML has the following structure:

<child id=ID type=val weight=val locked=val must=val></child>

rangeXML has the following structure for denoting value-score pairs:

<value score=value>value </value>

Since the data model of the document is a tree, the document elements are tree nodes. Each node can be collapsed so that only its header is visible, or expanded so that children are visible. Each node can show its body, or hide its body. Each document element has a unique tree ID that represents its place in the document tree. A user can modify the document, add elements to it, remove elements from it, cut and paste elements, edit the header and body, edit requirements and apply styling. Preferably, editing of headers and bodies are in different frames and not directly on the document.

The web-based enterprise application hosted on the system described above includes two main modules on the application server 10: a strategic partner selection module which provides buyers and vendors with the tools necessary to choose the most suitable long-term business partner/s, and a strategic partnership management module which provides both buyers and vendors with tools and content to build and maintain long-term value added business relationships.

In the strategic partner selection module, for buyers an RFP management platform helps buyers to manage the RFI/RFP process from definition to negotiation. A profiler helps buyers learn about network vendors. Using the profiler, buyers can expand their vendor lists by navigating vendor profiles which include both vendor-generated information and objective, third party data. They can publish RFI/RFP documents to individual vendors as well as complete vendor categories. Finally, a reuse repositories module helps buyers create RFP/RFI templates provided by the system manufacturer, network vendors and third party vendors.

For vendors a proposal management platform helps vendors respond to requests for information and proposals by providing them with a flexible, accurate and intuitive online framework. In a supplier inbox aspect of the proposal management platform, through an RFI/RFP repository it provides a central place to store, view and analyze all RFI and RFP documents received through the system. The proposal management platform has proposal filters which apply business rules to filter in only the types of RFI/RFP documents the supplier wishes to consider. In a response generation aspect of the proposal management platform, it allows network suppliers to store responses to requirements and sections of proposal documents in a central repository for reuse across the organization. It also allows any type or size of files to be attached to messages to make or reinforce a point without the need for print.

The system also includes a performance analysis tool which helps vendors evaluate the progress of their relationship. It enables both buyers and suppliers to analyze the performance of the relationship relative to the contract and to cooperate on increasing its value. It enables suppliers to manage their fit relative to market demand.

For both buyers and sellers, a best practices resource helps with general information on selection and management of strategic partners. The best practices resource offers information on best practice strategies and methodologies. It is an interactive forum for sourcing experts and system members to share and enhance their knowledge.

In the strategic partnership management module, a contract management platform helps both buyers and sellers build and maintain long-term value-added business relationships. Users can store, sort, analyze and reuse current and past contracts. Buyers can create a contract and use information exchanged during the bid solicitation process as a Statement of Work (SOW) or appendix. Users can set reminders and alerts to track compliance with a contract and receive automatic notification of milestones and renewal dates. Finally, it enables changes in requirements to be communicated and contract amendments to be managed.

A performance analysis tool helps both buyers and sellers evaluate the progress of their relationship.

To better understand the advantages of the present invention, consider the stages of a typical management bid process. First, the bid solicitation document is generated. For this, the following functionality is useful. To define the bid solicitation framework, the preferred embodiment provides an online framework for the generation of bid solicitation documents for any asset or service. It supports a full range of bid solicitation documents, from formal RFP documents essential for complex purposes to RFQs and RFIs suitable for the acquisition of many types of solutions. Scores and weights may be assigned to both qualitative and quantitative requirements. Using these, a buyer can eliminate inappropriate bids quickly and easily according to preliminary results. The preferred embodiment can allow collaboration between colleagues throughout the system and the easy integration of results of the collaboration into the bid solicitation document.

As used herein, “colleague” means any person in the bid solicitation owner's organization who may receive a request for collaboration in any part of the bid solicitation process.

Various departments and key users will be able to define reusable requirements or sections and make them available to bid solicitation owners by inputting them into a central repository. In this way, bid solicitation owners can use requirements from a central repository when preparing a bid solicitation document.

As used herein, the term “bid solicitation owner” means the person who generates the bid solicitation document and has overall responsibility for the bidding process.

Next, the bid solicitation document must be communicated to bidders, and responsive bids received from the bidders. Preferably, all communication between buyers and bidders is done through the system. Potential bidders will receive an e-mail invitation with a hyperlink which takes them to the system, at which point they can study the bid solicitation document and enter their bid.

After the buyer has received responses to his solicitation, the bids must be analyzed and compared. For this, the preferred embodiment provides decision support tools to analyze, compare and perform sensitivity analyses on bids. Preferably, it also supports consensus analysis of bids. Once the buyer has identified potential winners in the bidding process, it may be necessary to negotiate the price. The preferred embodiment enables the buyer to establish a reverse auction procedure amongst the bidders to achieve the best possible price. Once a winning bidder is identified and the contract is to be awarded, the preferred embodiment can generate a contract based on the information exchanged during the bidding process. Finally, buyers will be able to track the progress of the bidding process as well as review past rejected responses, and can produce results and generate reports to justify their decisions in minutes.

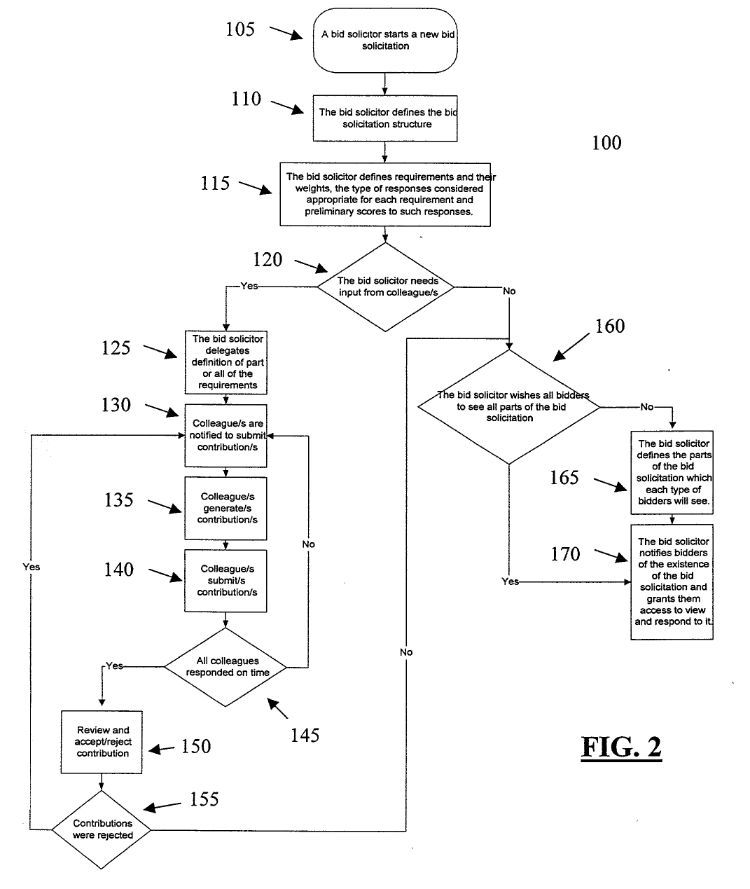

The initiation of a bid solicitation process 100 is shown in FIG. 2. After deciding to start a new bid solicitation in Step 105, a bid solicitation owner defines the bid solicitation structure Step 110. Preferably, the bid solicitation structure includes the bid solicitation owner's name, the name of the bid solicitation, the creation date of the bid solicitation, the publication date of the bid solicitation, and the deadline for submission of bids.

Preferably, at least while preparing the bid the bid solicitation owner can view a bid solicitation directory which shows parameters such as the following for his bids (the displayed parameters may be customizable on a user-by-user basis): bid solicitation name; number of collaboration responses pending; number of colleagues to whom collaboration requests were submitted; number of bids pending; number of bidders to whom solicitations were submitted; creation date; modification date; whether the bid solicitation is complete or being edited; whether the solicited contract has been awarded; and the current stage in the bidding process for the solicitation.

After the bid solicitation structure is defined, in Step 115 the bid solicitation owner defines requirements and their weights, the type of responses considered appropriate for each requirement and preliminary scores to such responses. Responses to the requirements may be in a number of different types as determined by the bid solicitation owner. Preferably, the various possible answers for each response type are associated with predetermined score so that a scoring framework can be created based on the bidder's responses, and these scores can be adjusted by the bid solicitation owner. For example, the bid solicitation document may include “yes/no” questions, where an answer of “yes” has a default score of 100 and no a default score of 0. The bid solicitation document may include multiple choice questions where the default score for all answer choices are equal. The bid solicitation document may include multiple choice questions where more than one selection may be chosen; again, the default weighting makes all choices equal. The bid solicitation document may include questions requiring numeric answers for price, quantity and the like. The bid solicitation document may include questions requiring dates for answers—start dates, end dates, date ranges and the like. Finally, the bid solicitation document may include questions requiring freeform text answers where the bidder can answer as he sees fit. These freeform answers are not scored automatically, if at all.

Preferably, the bid solicitation owner is able to define formulae that apply automatically to numeric answers from a bidder. Numeric answers can be scored directly, by entering an absolute value, or relative to other bids by normalizing the values between the highest and lowest bids. For example, if the highest bid receives a score of 100 and the lowest bid receives a score of 0, the system should be able to normalize all values in between according to a normalization method selected by the bid solicitation owner. Preferably, the formula defaults to linear normalization.

The weights are preferably included in the bid solicitation document as a weight distribution record. The system may automatically assign equal weights to generated requirements. The bid solicitation owner may manually change these to reflect his priorities or those of his organization. Further, weight allocation is defined within the hierarchical structure of the bid solicitation document. This means that the weight allocated to a sub-requirement reflects its importance relative to the parent requirement.

The system preferably supports two algorithms of weight allocation. In top-down weight allocation, weights are allocated to upper level requirements first. Weights for the next lower level are then allocated relative to the one above it. In bottom-up weight allocation, weights are allocated relative to the complete bid solicitation document. The weights of higher levels are dynamically computed by the system from the weights allocated to lower levels. The weight allocation algorithm is preferably determined automatically by the system based on the current state, i.e., when allocating weights to requirements in a level whose parent does not have an allocated weight, the process is bottom-up. When allocating weights to requirements in a level whose parent already has an allocated weight, the process is top-down.

More formally, let

R be a requirement.

Let {Rᵢ} be the set of direct children of R in the tree.

Let wᵢ be the weight of Rᵢ relative to R normalized to [0,1].

Let {Sᵢ} be the set of suppliers responding to a bid solicitation.

We denote by Sᵢ^{j} the score that supplier Sⱼ received for their response to requirement Ri normalized to [0,1].

The total score of supplier Sⱼ for R is given by:

$${\sum }_{i = 0 , n} {w}_{i} \times {s}_{i}^{j} .$$

Let

$${L}^{j} = \{ {L}_{i}^{j} \}$$

be the set of leaf requirement of the root Rⱼ.

Let waᵢ^{j} be the absolute weight of the leaf Lᵢ^{j} in the bid solicitation.

Let Slᵢ^{k} be the score of supplier Sₖ for the leaf Lᵢ^{j}.

It can be shown that the total score of supplier Sₖ for R is:

$${\sum }_{i = 1 , n} {wa}_{i}^{j} \times {sl}_{i}^{k} .$$

This formula is applied for the calculation of the score of a bidder on the total bid solicitation document.

Preferably, the bid solicitation owner is able to view weights allocated to some or all of the requirements in the document using a graphical tool in order to facilitate management of weight allocation. Further, the bid solicitation owner may want to lock the absolute weight of requirements relative to the whole document so that they will not change as a result of weight changes elsewhere in the document. Also, the bid solicitation owner may want to view the weight of a requirement relative to the whole document as well as relative to its parent, to sort requirements by weight, or to generate a bid solicitation document without weight allocation.

The bid solicitation owner may want to arrange requirements in tables. Such tables will contain rows representing general subjects and columns of specific questions applied to each row. In such a case each cell in the table is a requirement item with its own weight, score and response type. Weights and predefined scores may be applied collectively to the table.

The bid solicitation owner is preferably able to define a requirement in the bid solicitation document as a “must”. In this case, the requirement will not have a score, and it can either be met or not. Failure to meet a “must” requirement will disqualify the bid.

The bid solicitation owner preferably is able to generate an evaluation guide for a bid solicitation. Among other things, the evaluation guide in particular instructs potential evaluators on evaluation of responses to freeform questions and the like. Also, it is preferable that the bid solicitation owner can link to and embed documents external to the bid solicitation document for additional information. These can be from sources within the system or from external sources.

In Step 120, if the system needs additional input from colleagues execution moves to Step 125 where the bid solicitation owner delegates definition of part or all of the bid requirements to colleagues, and Step 130 where colleagues are notified to submit their contributions. The contributions may be in the form of reviews, comments, edits or newly-written parts of the bid solicitation document. A collaboration request may include many collaboration items. Each collaboration item references some part of the bid solicitation document, explains what is expected from the contributing colleague, and the like. Preferably, the system stores a history of collaboration documents independent of whether they were accepted or rejected by the bid solicitation owner as described below.

As used herein, an item is the smallest grouping of requirements which can be awarded to one bidder.

Preferably, the bid solicitation owner can define a visual differentiation for collaboration items according to their source. This will allow the bid solicitation owner to easily identify sources of various parts of the bid solicitation document. Also, when requesting collaboration the bid solicitation owner preferably can hide parts of the bid solicitation document from one or more of the collaborators. Finally, it is preferable that the bid solicitation owner can send a collaboration request to a colleague not included in the system by, e.g., e-mail with the bid solicitation document attached. When the outside colleague returns his contribution it can be manually entered.

In Step 135, colleagues generate their contributions, which are submitted in Step 140. If all colleagues responded on time in Step 145, each contribution is reviewed by the bid solicitation owner and the contributions are either accepted or rejected in Step 150. If any contributions are rejected in Step 155, or if all colleagues did not respond on time in Step 145, the corresponding contributors are notified in Step 130 and asked to submit contributions again.

If no contributions were rejected in Step 155, or if the bid solicitation owner needs no additional input from colleagues in Step 120, execution moves to Step 160. Here, if the bid solicitation owner would like all bidders to see the entirety of the bid solicitation, he notifies bidders of the existence of the bid solicitation and grants them access to view and respond to it in Step 170. Preferably, the bid solicitation owner can access vendor repositories in the database 70 to obtain information about each vendor which can be used to select vendors to whom the bid solicitation will be sent. The vendor repositories 70 may include custom information generated by a bid solicitation document and its response. For example, the organization may want to qualify vendors by submitting a qualification questionnaire to the bidder and storing the questionnaire results as part of the bidder's profile in the database 70.

Once the bid solicitation owner advises bidders of the solicitation in Step 170, he should not be able to alter the bid solicitation document. Any changes to the solicitation after release to the bidders should be done in an addendum. An addendum becomes a regular part of the complete solicitation document. It affects the relative weights of all weighted parts of the document.

If the bid solicitation owner wants to conceal parts of the bid solicitation from some bidders, he defines the part of the bid solicitation each type of bidder will see in Step 165 before proceeding to Step 170. The bid solicitation owner is preferably able to block certain bidders from seeing certain parts of the bid solicitation document, either on a bidder-by-bidder basis or on a category-by-category basis where the bidders have been divided into predetermined categories. Therefore, the bidder might be able to display all or only a part of the bid solicitation document. Care must be taken not to prevent any bidder from seeing “must” requirements, which are essential for making a bid as described below. Alternatively, a mechanism may be provided which prevents the bid solicitation owner from preventing such portions from being displayed to any user.

As with the colleague contributions, it is preferable that the bid solicitation owner can send the bid solicitation to a bidder not included in the system. When the outside bidder returns his bid it can be manually entered.

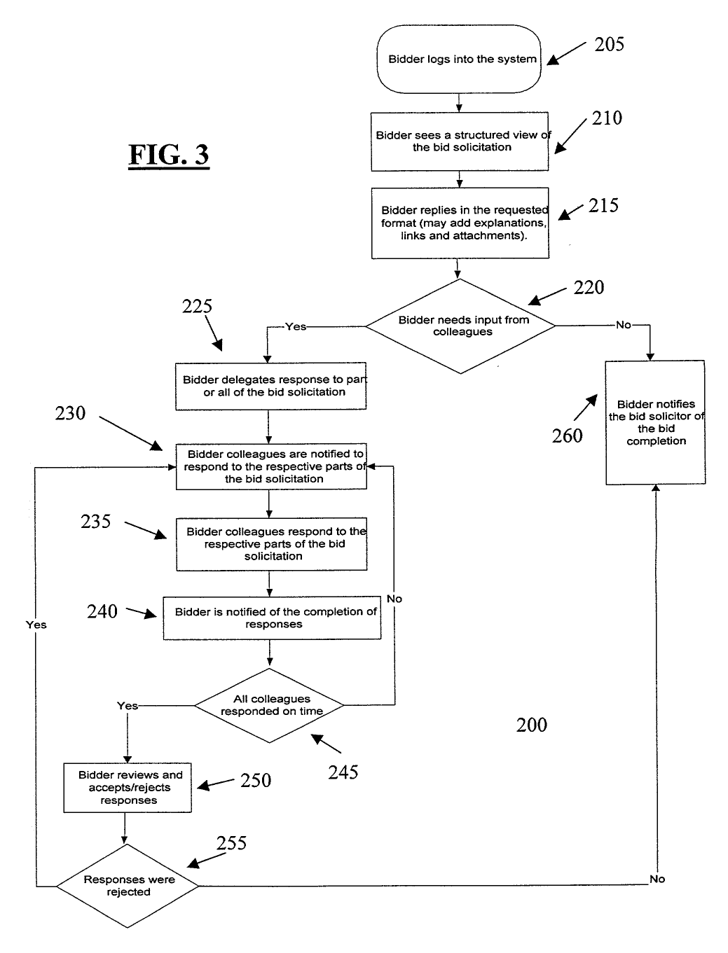

The bid view process 200 by which bidders can view and respond to the bid solicitation is shown in FIG. 3. First, a bidder logs into the system in Step 205 and sees a structured view of the bid solicitation provided by the system in Step 210. The bidder responds by replying in a format specified in the bid solicitation or in other materials in Step 215 (the bid may include explanations, hyperlinks to the bidder's information stored in the database 70, attachments and the like). If the bidder needs additional input from his colleagues in Step 220, he delegates the duty to respond to part or all of the bid solicitation to one or more colleagues in Step 225. In Step 230 the bidder colleagues are notified to respond to their respective parts of the bid solicitation, and do so in Step 235. The bidder is notified of the completion of responses in Step 240, and if all colleagues responded on time in Step 245 the bidder reviews and accepts or rejects the colleagues' responses in Step 250. If in Step 255 some contributions were rejected, or if in Step 245 all colleagues did not respond on time, execution returns to Step 230 where the colleagues whose contributions were rejected in Step 255 or did not arrive on time in Step 245 are prompted again to submit their contribution. If, however, no responses were rejected in Step 255 or the bidder needs no additional input from colleagues in Step 220, the bid is complete and the bidder notifies the bid solicitation owner of completion of the bid in Step 260.

Bid analysis includes three main activities: bid evaluation, weight allocation and bid ranking and comparison. Bid evaluation is the process of reviewing a bid and giving each response item in the bid a score which reflects the closeness of the response to the requirement. The result of this process is an evaluation record. Weight allocation is the process in which an evaluator allocates weights to requirements for the purposes of a “what if” analysis. A specific weight allocation pattern can be saved as a weight allocation record for later use.

Finally, bid ranking and comparison is a process in which a user selects a particular evaluation record and a particular weight allocation record to view the resulting ranking of the bids. In some cases, only one such record—the original—is allowed. All or part of the bid solicitation document may also be used in the bid ranking process. The part of the document used in the ranking process can be any number of requirements, or even a single requirement such as the price of a specific item. Based on these attributes, a ranking of the bids is produced and presented to the users. Preferably, the weight allocation record can be modified while viewing the resulting ranking.

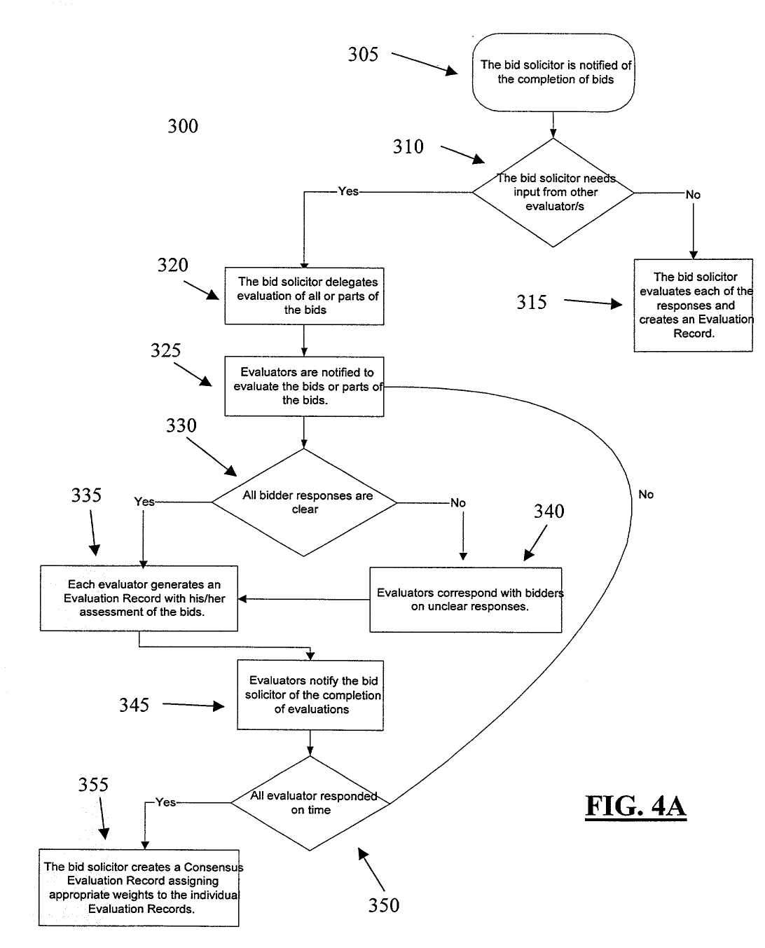

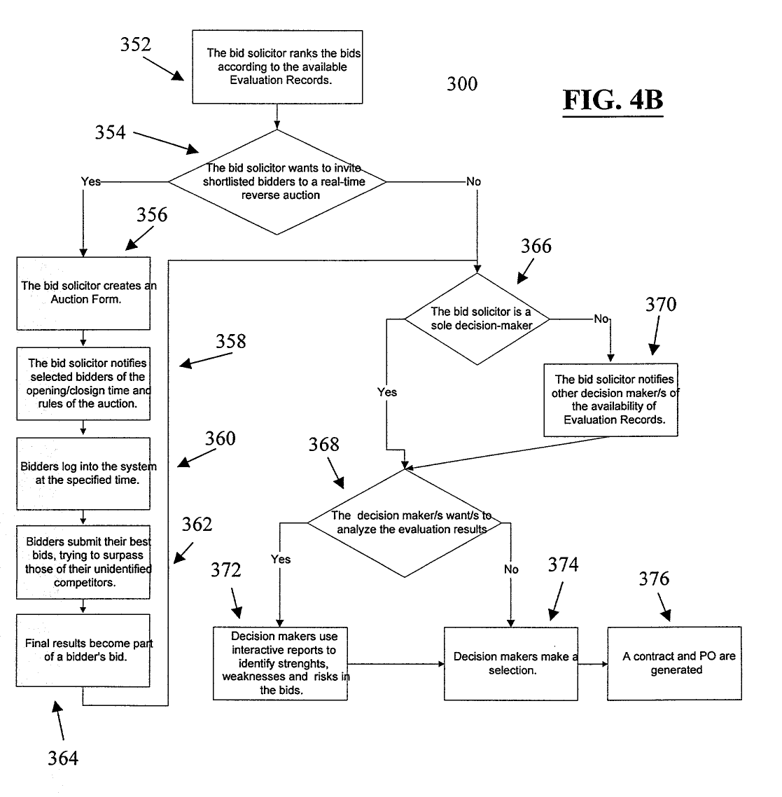

The bid analysis and evaluation process 300 is shown in FIGS. 4A and 4B. Here, the bid solicitation owner is notified of the completion of bids in Step 305. If the bid solicitation owner needs no additional input from other evaluators in Step 310, he evaluates each received bid in Step 315 and creates an evaluation record for it.

As used herein, “evaluator” means a person who participates in the analysis of a bid. An evaluation record is a complete set of scores in a bid. It may address any level of requirements in the bid solicitation. An evaluation record is considered complete if it contains at least one level of requirements that is completely scored; that is, all its members have scores. The aggregate score of a bid is the weighted average of the scores in the lowest completely scored level of requirements and the weight of the respective requirements. An evaluation record may contain scores allocated by different people to different parts of the same bid.

If, on the other hand, additional input is needed in Step 310, the bid solicitation owner delegates evaluation of all or part of one or more bids to colleagues in Step 320, and the colleagues are advised to make their contributions in Step 325. If all bidder responses are clear in Step 330, each evaluator generates an evaluation record with his assessment of the bids in Step 335; if not all bidder responses are clear, the evaluators may correspond with the bidders on unclear portions of the responses in Step 340 before generating the evaluation reports in Step 335. The bid solicitation owner can send a notification about the comment or clarification requests. The notification allows the recipient to navigate directly to the relevant locations in his response to view the comment and requests and to respond to them.

The bid solicitation owner may ask the evaluators to evaluate entire bids, he may exclude items than have no differentiation value, or he may cut off requirements from evaluation based on the weight allocated to them. This will enable evaluation of only the most important requirements. Upon specification of a cutoff value, e.g., 80%, the system can add requirements to the “to be scored” list in order of importance until the cutoff is reached.

As with the bid solicitation documents above, the bid solicitation owner can create an evaluation form from the bid. This allows the bid solicitation owner to specify which sections of the bid will be visible to each evaluator. For example, it may be undesirable to allow some evaluators to see pricing data.

Once the evaluation reports have been generated in Step 335, the evaluators notify the bid solicitation owner of their completion of evaluations in Step 345 and, if all evaluators responded on time in Step 350, in Step 355 the bid solicitation owner creates a consensus evaluation record assigning appropriate weights to the individual evaluation records in Step 355. Preferably, the system permits the allocation of different weights to different evaluation records. A consensus evaluation record is created by applying an algorithm such as an arithmetic or geometric average to evaluation records generated by a number of evaluators. If all evaluators did not respond on time in Step 350 execution returns to Step 325 where the tardy evaluators are again prompted to make their evaluations.

Preferably, the bid solicitation owner is able to enter comments on the bidder's response items. These comments become part of the evaluation record and are not visible to the bidder. Further, each evaluator can preferably create an evaluation report on the entire bid. This report may be generated after a vendor demonstration and may incorporate additional information about the bid.

Moving to FIG. 4B, once the evaluation records are available (whether regular records from Step 315 or consensus evaluation records from Step 355), in Step 352 the bid solicitation owner ranks the bids according to the available evaluation records. In step 352 preferably the owner uses comparison and analysis tools in order to identify sensitivities of the current ranking of bidders to changes to a weight of some requirement. Also preferably the owner has at his disposal tools for performing “what if analysis” which will demonstrate how changes to the weight distribution of requirements in the document may affect the ranking of the different bidders. Preferably the owner has the ability to record the results of applying analysis tools in order to support subsequent decisions. (Please refer to Appendix I for a description of the sensitivity analysis tool).

If in Step 354 the bid solicitation owner wants to invite bidders selected based on their bids to a real-time reverse auction for the bid solicitation, he creates an auction form in Step 356. Preferably, the auction form is developed from the bid solicitation document. The default auction form should contain only requirements with numeric response types. The bid solicitation owner can adjust the auction form to fir his needs in the same manner that he edits a bid solicitation document.

Next, the bid solicitation owner notifies the selected bidders of the opening time, closing time and rules of the auction in Step 358. Preferably, the bid solicitation owner can set a starting or reserve price so that the system will not accept bids higher than that price. The starting or reserve price can be set on an item or lot level. The reserve price is set before the auction starts and is not disclosed to the bidders. Bidders know that the reserve price has been met only after a bid lower than the reserve price was submitted. Also, it is preferable that the auction system automatically perform unit conversion for bid quotes. For example, a commodity might be sold in boxes but priced on a per pound basis.

In Step 360 the bidders log into the system at the specified time and submit their best bids in Step 362 to bid lower than their unidentified competitors. During this period, the bid solicitation owner can preferably send announcements to the bidders in real time. During the bidding process, the bid solicitation owner preferably can view the price convergence process in a graphic format which shows the activity of all bidders or of only a single bidder.

Preferably, the bid solicitation owner can view the following additional statistical information per item and per lot: list of bidders and their current lowest time-stamped bids; the bidding history of any bidder; the current lowest bid and the bidder's name; dollar and percentage difference from the opening bid; dollar and percentage difference from the reserve price; average percentage change in the last three bids; time left to close auction; and number of active bidders. Similarly, the bidder preferably can view the following statistics during the bidding period: all bids without bidder identity; current lowest bid; that bidder's ranking versus other bids; percentage difference between that bidder's bid and the lowest bid; percentage difference between that vendor's opening bid and his current bid; dollar difference between the vendor's bid and the lowest bid; the number of bids submitted during the bidding period; and the time left until bid closing.

After the final results are made part of each bidder's bid and the bidding time has expired (the bid solicitation owner may extend the length of the auction during the course of the bidding) in Step 364, or if the bid solicitation owner does not wish to conduct a reverse auction in Step 354, execution moves to Step 366. Here, if the bid solicitation owner is not the sole decision maker the bid solicitation owner notifies any other decision makers of the availability of the evaluation records in Step 370. From here, or directly from Step 366 if the bid solicitation owner is the sole decision maker, the system determines whether the decision maker or makers want to analyze the evaluation results in Step 368. If not, the decision makers make a selection in Step 374; if so, the decision makers use interactive reports to identify strengths, weaknesses and risks in the bids in Step 372 before proceeding to Step 374. Finally, in Step 376 a contract is generated according to the selection. Given an interface to the organization's purchasing system, a purchase order may be generated as well.

Preferably, generation of the contract is accompanied by a contract award record which includes the parts of the bid solicitation document on which the award is based; the bidder; and a legal contract document, which may include references to the original bid solicitation document. The bid solicitation owner may group any subset of requirements from the bid solicitation document and label those groups as “items”. Items may be used to award different parts of the bid to different bidders. Further, the bid solicitation owner preferably can create a list of awards given in the context of the bid solicitation document. The list should contain the identity of the bidders, the items on which the awards are based and reference to the relevant legal contract document. The system should be able to generate an optimal award list based on the bid scores and defined items. The optimal award list must have a higher score than that of any particular bid.

Preferably, the system can reuse the presentation, format, structure and style of bid solicitation documents. These can be stored in the application server 10 in the form of document templates. The templates may also contain predefined content such as legal terms and conditions, corporate information, standard technical requirements, standard vendor requirements, standard pricing requirements and the like. Also, the system can preferably reuse existing content from previously composed bid solicitation requests. For this purpose, content repositories dedicated either to a predetermined content area such as legal, technical or the like, or general content repositories containing various standard sections can be used. Predefined content in the repositories may include contract requirements; HTML code, text, images and the like; and links to external HTML pages.

Preferably, the system has the ability to generate numerous reports for use by bid solicitation owners, system administrators and other personnel. For example, in the area of bid solicitation reports it may generate a bid solicitation document report which shows the contents of the bid solicitation document together with records of different parts of the bid solicitation generation process such as requirements details; weights; collaboration requests; collaboration contributions; bidder forms; and items.

The bid solicitation status report presents all milestones in the bid solicitation process in chronological order. It includes a table with a bidders list and the bid solicitation submission date; the response date; the response integration date; the response dismissal date; and the contract award date. The bid solicitation status report can also be viewed as a pipeline report showing a graphical presentation of the bidders in each stage of the bid solicitation pipeline. A collaboration status report is similar to the bid solicitation status report, except it is directed to colleague contributions.

Finally, the system may generate a bid award report which lists all information relevant to the result of a bid process such as winning bidders, awarded items and the contract.

In the area of bid solicitation owner reports, a bid solicitation owner activity report lists all bid solicitations and bidder correspondence generated by a particular bid solicitation owner or a department. The report preferably includes the following information: bid solicitation name; bid solicitation score; number of bidders participating; bidder awarded; and length of bid solicitation cycle.

A bid solicitation owner's performance summary report lists all bid solicitation owners or departments with the following information: number of bid solicitations generated; average length of bid solicitation cycle; average number of participating bidders; and average score of winning proposal.

In the area of bidder reports, the system may generate a bidder activity report which analyzes activity of bidders who receive multiple bid solicitations over time. This report should include a list of all bid solicitations received, the bids and all relevant correspondence. The report should include the following parameters for a bidder: a list of bid solicitations received; the name of the bid solicitation owner; the date the bid solicitation was received; the date the bid was received; whether a contract was awarded; the bidder's score in the bid; and a grouping of the bidders by industry, size or the like.

Also, a bidder performance report presents analysis of the aggregate bidder activities and preferably include the following information: average score based on all bids; win/loss ratio; average response time; total number of bid solicitations submitted to the bidder; total number of bids submitted by the vendor; total number of declined bids; and a grouping of the bidders by industry, size or the like.

For bid analysis and comparison reports, the bid evaluation report shows the complete evaluation of a bid. It preferably includes evaluation comments; bids; questions to bidders with or without responses; bidder attachments and links; and the level of bid requirements detail. the bid evaluation report may take the form of a simple evaluation report, which includes reference to the evaluation record producer, or a consensus evaluation record which includes references to all participating evaluation record producers as well as well as the individual weights awarded to the different evaluation records and the algorithm used to produce the consensus evaluation record from them.

A weight allocation record report shows a complete weight distribution in the bid solicitation document. The user should be able to control the level of detail of the report, which may take the form of a simple weight allocation record that includes reference to the weight allocation record producer, or it may take the form of a consensus weight allocation record which includes references to all participating weight allocation record producers as well as the individual weights awarded to the different weight allocations and the algorithm used to produce the consensus weight allocation record from them.

Finally, a ranking and comparison report shows the scores and ranking of bidders as a function of the evaluation record, weight allocation record (defaulting to the original), all or a subset of bid requirements; and bidders.

Also to aid in evaluation and analysis, the bid solicitation owner preferably can search bid solicitations in system repositories; bid solicitation templates in system repositories; colleagues in system directories; bidders in system directories; and requirements in system repositories. Search functionality may include full text searching; user-defined searches such as owner, date ranges, new collaboration requests, new bidder responses and the like; requirement-specific searches such as key words, weight, response type and the like; and functionality-specific searches such as bidders, prices, dates and the like. The searches may be saved on the application server 10 as filters and reapplied to the data.

As a further system tool the system should present a process map that will show the progress of the bid solicitation process from bid solicitation generation to contract award. The user will be able then to navigate to areas in the system from the process overview. Further, a bid solicitation owner should be able to print or download the entire bid solicitation or parts of it according to criteria such as selected sections, selected collaborations, selected bids, the bid solicitation owner's comments on selected responses; and reports.

The bid solicitation owner should be able to configure various parameters for e-mail messages sent or received as a result of the occurrence or non-occurrence of events such as: receipt of a colleague contribution, submission of a bid; failure to respond to a bid solicitation; and failure to respond to a collaboration request. Escalations may include:

reminders before event deadline, where a reminder is sent to a party every specified period starting on a given date before a deadline;

notify a given party when the event occurs, in which the bid solicitation owner asks the system to send him (or someone else) e-mail and notify him upon an occurrence of a specified event (the e-mail notification may include a URL that will take him directly into the relevant location in the system); and

notification on missed event deadline, in which the bid solicitation owner may want to be notified upon a failure to meet a pre-specified dealing on the part of some participant in the process.

Preferably, the system provides some systemic safeguards to ensure the security of transacting parties. The system preferably provides authentication functions to both buyers and vendors to prevent fraudulent submissions and responses. This may be done for bidders by requiring that a record of the bidder exist in the system prior to submission of a bid. Bidders may be preregistered in the system through integration with the organization's enterprise systems or through manual input into the system. In the case of publicly accessible bid solicitations, unregistered bidders will be required to register on-line prior to acceptance of the response.

The system preferably provides authorization functions to prevent unauthorized access to private data such as solicitation documents, bids and related communication. It provides privacy to prevent observation or snooping of data by unauthorized parties. It provides data integrity to prevent inadvertent or intentional alteration of messages. Finally, it provides non-repudiation to prevent disavowal of responses by their authors.

The system also should log all activities. The system administrator may decide to turn logging off for specific activities such as collaboration requests, consensus analysis requests, and requirement weight changes.

The present invention has been described above in connection with a preferred embodiment thereof; however, this has been done for purposes of illustration only, and the invention is not so limited. Indeed, variations of the invention will be readily apparent to those skilled in the art and also fall within the scope of the invention.

### APPENDIX I

Sensitivity Analysis

We define sensitivity as propensity of a score to change when the weight of some requirement is changed slightly. Slightly means in a way that does not deviate significantly from the original weight allocation which is supposed to describe the issuing organizations tastes and preferences.

Relative to Leaf Requirement.

Let R be the set of leaf requirements in the bid solicitation. Let R contain n leaves. The absolute weight of a leaf requirement Rᵢ will be denoted as wᵢ

Let B be the set of bids submitted in response to R. Then the total score of bidder Bⱼ on R is:

$${S}^{j} = {\sum }_{i = 0}^{n} {S}_{i}^{j} {w}_{i}$$

Where

n is the number of leaf requirements in R.

wᵢ is the normalized (in the interval [0.0,1.0]) weight of requirement Rᵢ.

Sᵢ^{j} is the normalized (in the interval [0.0,1.0]) score of bid Bⱼ for requirement Rᵢ.

We define the sensitivity Z of the score of bidder Bⱼ to a change in the weight of requirement Rₖ as follows:

Let ε be a small weight change applied to Wₖ. Where ε is small compared to Wₖ. The weight of requirement Rₖ after the change is: Wₖ+ε. We make two assumptions:

1. The total weight is not changed (≡1).

2. The other requirements weights change as a result in a way that preserves the ratios of their respective weights.

Therefore the weight of requirement Rᵢ after the change is:

$${w}_{i} \cdot ( 1 - \frac{ϵ}{{\sum }_{i \neq k} {w}_{i}} ) .$$

The total score of bid Bⱼ after the weight change is:

$${S}^{j} = {S}_{k}^{j} \cdot ( {w}_{k} + ϵ ) + {\sum }_{i \neq k} {S}_{i}^{j} \cdot {w}_{i} \cdot ( 1 - \frac{ϵ}{{\sum }_{i \neq k} {w}_{i}} )$$

Let Zₖ^{j} (the sensitivity of the total score of bid j to small changes in the weight of requirement k) be defined as Z

$${Z}_{k}^{j} ≡ \frac{ⅆ {S}^{j}}{ⅆ ϵ}$$

we get:

$${Z}_{k}^{j} = {S}_{k}^{j} - \frac{1}{{\sum }_{i \neq k} {w}_{i}} {\sum }_{i \neq k} {S}_{i}^{j} \cdot {w}_{i}$$

Relative to any Node

Let N be a node in the bid-solicitation hierarchy of requirements. We call a requirement Rᵢ an offspring of N if Rᵢ is in the sub-tree whose root is N.

Let Rₙ denote the set of leaf requirements that are offspring of N and let \overline{Rₙ} denote the set of leaf requirements that are not offspring of N (it follows that: Rₙ∩\overline{Rₙ}=Φ and Rₙ ∪\overline{Rₙ}=R and Rₙ≠Φ).

It is easy to show that the sensitivity of the score of bid j to small changes in the weight of node N is given by the formula:

$${Z}_{n}^{j} = \frac{1}{{\sum }_{{R}_{n}} {w}_{l}} {\sum }_{{R}_{n}} {S}_{l}^{j} \cdot {w}_{l} - \frac{1}{{\sum }_{\overline{{R}_{n}}} {w}_{m}} {\sum }_{\overline{{R}_{n}}} {S}_{m}^{j} \cdot {w}_{m}$$

What is claimed is:

1. A method for making a purchase from a vendor using a computer connected to a computer network, the method comprising:
using the computer to generate a bid solicitation to be provided to a plurality of vendors via the network;
using the computer to provide the bid solicitation to the plurality of vendors over the network;
receiving bids from the vendors over the computer network;
generating an evaluation of each vendor bid using the computer;
using the computer to choose a vendor with which to contract based on the evaluations; and
generating a contract for that vendor using the computer.

2. The method of claim 1, wherein generating the bid solicitation includes using the computer to:
define a structure of the bid solicitation; and
define at least one of bid solicitation requirements and their weights, types of responses considered appropriate for each requirement, and preliminary scores to such responses.

3. The method of claim 1, wherein generating the bid solicitation includes using the computer to:
delegate definition of at least a part of the bid solicitation structure to at least one additional bid solicitor; and
receive delegated definitions for the delegated part of the bid solicitation structure.

4. The method of claim 1, wherein providing the bid solicitation to the plurality of vendors includes withholding a portion of the bid solicitation from at least one vendor.

5. The method of claim 1, wherein generating an evaluation of each vendor bid includes:
delegating evaluation
of at least a part of a vendor bid to at least one additional bid solicitor; and
receiving delegated evaluations for the delegated part of the bids.

6. The method of claim 5, wherein generating an evaluation of each vendor bid further includes creating a consensus evaluation weighting individual evaluations.

7. The method of claim 1, wherein generating an evaluation of each vendor bid includes using the network to communicate with a vendor's computer regarding an unclear portion of the vendor's bid.

8. The method of claim 1, wherein choosing a vendor with which to contract based on the evaluations includes:
determining a subset of bidding vendors; and
using the network to conduct an auction for the contract amongst the subset.

9. The method of claim 1, further comprising using the computer to conduct an analysis of bid evaluation results.
